(19) United States
(12) Patent Application Publication
(10) Pub. No.: US 2025/0056332 A1
(43) Pub. Date: Feb. 13, 2025

(54) MULTICAST BROADCAST SERVICE AUTHORIZATION FOR INBOUND AND OUTBOUND ROAMERS

(71) Applicant: NOKIA TECHNOLOGIES OY, Espoo (FI)

(72) Inventors: Bruno LANDAIS, Pleumeur-Bodou (FR); Rajesh Babu NATARAJAN, Bangalore (IN); Mohamed Amin NASSAR, Munich (DE); Philippe GODIN, Versailles (FR); Horst Thomas BELLING, Erding (DE); Ugur Baran ELMALI, Munich (DE); Abdelaali CHAOUB, Massy (FR)

(21) Appl. No.: 18/790,162

(22) Filed: Jul. 31, 2024

(30) Foreign Application Priority Data
Aug. 9, 2023 (GB) 2312172.6

(51) Int. Cl. H04W 36/00; H04W 48/08; H04W 84/04

(52) U.S. Cl. CPC H04W 36/0007; H04W 48/08; H04W 84/042

(57) ABSTRACT

Systems, methods, apparatuses, and computer program products for roaming of multicast MBS services. One method may include attaching, by a user equipment, to a visited public land mobile network as inbound roamer. The user equipment then receives a service announcement comprising at least one of a multicast service session allowed to be accessed by inbound roamers indication or multicast service class. The user equipment determines whether the user equipment is allowed to access a multicast session or multicast service class in the visited public land mobile network. The user equipment transmits, in response to determining that the user equipment is allowed to access, a request to join a multicast session comprising an identifier of the multicast session and/or a multicast service class. The user equipment receives an indication of an acceptance or rejection of the request to join the multicast session.

### CROSS REFERENCE TO RELATED APPLICATION

This application claims the benefit of United Kingdom Patent Application No. 2312172.6, filed Aug. 9, 2023. The entire content of the above-referenced application is hereby incorporated by reference.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for roaming of multicast MBS services.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include attaching, by a user equipment, to a visited PLMN as inbound roamer. The method may further include receiving, by the user equipment, from an application function, a service announcement comprising at least one of a multicast service session allowed to be accessed by inbound roamers indication or multicast service class. The method may further include determining, by the user equipment, based on the service announcement, whether the user equipment is allowed to access a multicast session or multicast service class in the visited PLMN. The method may further include transmitting, by the user equipment, in response to determining that the user equipment is allowed to access, a request to join a multicast session comprising an identifier of the multicast session and/or a multicast service class. The method may further include receiving, by the user equipment, an indication of an acceptance or rejection of the request to join the multicast session.

In accordance with certain example embodiments, an apparatus may include means for attaching to a visited PLMN as inbound roamer. The apparatus may further include means for receiving from an application function, a service announcement comprising at least one of a multicast service session allowed to be accessed by inbound roamers indication or multicast service class. The apparatus may further include means for determining, based on the service announcement, whether the apparatus is allowed to access a multicast session or multicast service class in the visited PLMN. The apparatus may further include means for transmitting in response to determining that the apparatus is allowed to access, a request to join a multicast session comprising an identifier of the multicast session and/or a multicast service class. The apparatus may further include means for receiving an indication of an acceptance or rejection of the request to join the multicast session.

In accordance with various example embodiments, a non-transitory computer readable medium may include program instructions that, when executed by an apparatus, cause the apparatus to perform at least a method. The method may include attaching to a visited PLMN as inbound roamer. The method may further include receiving from an application function, a service announcement comprising at least one of a multicast service session allowed to be accessed by inbound roamers indication or multicast service class. The method may further include determining, based on the service announcement, whether the apparatus is allowed to access a multicast session or multicast service class in the visited PLMN. The method may further include transmitting in response to determining that the apparatus is allowed to access, a request to join a multicast session comprising an identifier of the multicast session and/or a multicast service class. The method may further include receiving an indication of an acceptance or rejection of the request to join the multicast session.

In accordance with some example embodiments, a computer program product may perform a method. The method may include attaching to a visited PLMN as inbound roamer. The method may further include receiving from an application function, a service announcement comprising at least one of a multicast service session allowed to be accessed by inbound roamers indication or multicast service class. The method may further include determining, based on the service announcement, whether the apparatus is allowed to access a multicast session or multicast service class in the visited PLMN. The method may further include transmitting in response to determining that the apparatus is allowed to access, a request to join a multicast session comprising an identifier of the multicast session and/or a multicast service class. The method may further include receiving an indication of an acceptance or rejection of the request to join the multicast session.

In accordance with certain example embodiments, an apparatus may include at least one processor and at least one memory storing instructions that, when executed by the at least one processor, cause the apparatus at least to attach to a visited PLMN as inbound roamer. The at least one memory and instructions, when executed by the at least one processor, may further cause the apparatus at least to receive from an application function, a service announcement comprising at least one of a multicast service session allowed to be accessed by inbound roamers indication or multicast service class. The at least one memory and instructions, when executed by the at least one processor, may further cause the apparatus at least to determine, based on the service announcement, whether the apparatus is allowed to access a multicast session or multicast service class in the visited PLMN. The at least one memory and instructions, when executed by the at least one processor, may further cause the apparatus at least to transmit in response to determining that the apparatus is allowed to access, a request to join a multicast session comprising an identifier of the multicast session and/or a multicast service class. The at least one memory and instructions, when executed by the at least one processor, may further cause the apparatus at least to receive an indication of an acceptance or rejection of the request to join the multicast session.

In accordance with various example embodiments, an apparatus may include attaching circuitry configured to perform attaching to a visited PLMN as inbound roamer. The apparatus may further include receiving circuitry configured to perform receiving from an application function, a service announcement comprising at least one of a multicast service session allowed to be accessed by inbound roamers indication or multicast service class. The apparatus may further include determining circuitry configured to perform determining, based on the service announcement, whether the apparatus is allowed to access a multicast session or multicast service class in the visited PLMN. The apparatus may further include transmitting circuitry configured to perform transmitting in response to determining that the apparatus is allowed to access, a request to join a multicast session comprising an identifier of the multicast session and/or a multicast service class. The apparatus may further include receiving circuitry configured to perform receiving an indication of an acceptance or rejection of the request to join the multicast session.

In accordance with some example embodiments, a method may include handling, by a network entity, a local breakout packet data unit session for an inbound roamer user equipment. The method may further include receiving, by the network entity, a join request of the inbound roamer user equipment for a multicast service session or a multicast service class. The method may further include determining, based on multicast roaming authorization information for the multicast service session or a multicast service class and/or the inbound roamer, whether to accept the join request. The method may further include sending a join reply message indicating whether the join request is accepted or rejected.

In accordance with certain example embodiments, an apparatus may include means for handling a local breakout packet data unit session for an inbound roamer user equipment. The apparatus may further include means for receiving a join request of the inbound roamer user equipment for a multicast service session or a multicast service class. The apparatus may further include means for determining, based on multicast roaming authorization information for the multicast service session or a multicast service class and/or the inbound roamer, whether to accept the join request. The apparatus may further include means for sending a join reply message indicating whether the join request is accepted or rejected.

In accordance with various example embodiments, a non-transitory computer readable medium may include program instructions that, when executed by an apparatus, cause the apparatus to perform at least a method. The method may include handling a local breakout packet data unit session for an inbound roamer user equipment. The method may further include receiving a join request of the inbound roamer user equipment for a multicast service session or a multicast service class. The method may further include determining, based on multicast roaming authorization information for the multicast service session or a multicast service class and/or the inbound roamer, whether to accept the join request. The method may further include sending a join reply message indicating whether the join request is accepted or rejected.

In accordance with some example embodiments, a computer program product may perform a method. The method may include handling a local breakout packet data unit session for an inbound roamer user equipment. The method may further include receiving a join request of the inbound roamer user equipment for a multicast service session or a multicast service class. The method may further include determining, based on multicast roaming authorization information for the multicast service session or a multicast service class and/or the inbound roamer, whether to accept the join request. The method may further include sending a join reply message indicating whether the join request is accepted or rejected.

In accordance with certain example embodiments, an apparatus may include at least one processor and at least one memory storing instructions that, when executed by the at least one processor, cause the apparatus at least to handle a local breakout packet data unit session for an inbound roamer user equipment. The at least one memory and instructions, when executed by the at least one processor, may further cause the apparatus at least to receive a join request of the inbound roamer user equipment for a multicast service session or a multicast service class. The at least one memory and instructions, when executed by the at least one processor, may further cause the apparatus at least to determine, based on multicast roaming authorization information for the multicast service session or a multicast service class and/or the inbound roamer, whether to accept the join request. The at least one memory and instructions, when executed by the at least one processor, may further cause the apparatus at least to send a join reply message indicating whether the join request is accepted or rejected.

In accordance with various example embodiments, an apparatus may include handling circuitry configured to perform handling a local breakout packet data unit session for an inbound roamer user equipment. The apparatus may further include receiving circuitry configured to perform receiving a join request of the inbound roamer user equipment for a multicast service session or a multicast service class. The apparatus may further include determining circuitry configured to perform determining, based on multicast roaming authorization information for the multicast service session or a multicast service class and/or the inbound roamer, whether to accept the join request. The apparatus may further include sending circuitry configured to perform sending a join reply message indicating whether the join request is accepted or rejected.

In accordance with some example embodiments, a method may include determining, by a network entity, whether a multicast session or multicast service class is open to inbound roamers. The method may further include based on the determination, transmitting, by a network entity, a service announcement for a multicast session or service class indicating whether inbound roamers are allowed to access the multicast service or multicast service class.

In accordance with certain example embodiments, an apparatus may include means for determining whether a multicast session or multicast service class is open to inbound roamers. The apparatus may further include means for, based on the determination, transmitting a service announcement for a multicast session or service class indicating whether inbound roamers are allowed to access the multicast service or multicast service class.

In accordance with various example embodiments, a non-transitory computer readable medium may include program instructions that, when executed by an apparatus, cause the apparatus to perform at least a method. The method may include determining whether a multicast session or multicast service class is open to inbound roamers. The method may further include, based on the determination, transmitting a service announcement for a multicast session or service class indicating whether inbound roamers are allowed to access the multicast service or multicast service class.

In accordance with some example embodiments, a computer program product may perform a method. The method may include determining whether a multicast session or multicast service class is open to inbound roamers. The method may further include, based on the determination, transmitting a service announcement for a multicast session or service class indicating whether inbound roamers are allowed to access the multicast service or multicast service class.

In accordance with certain example embodiments, an apparatus may include at least one processor and at least one memory storing instructions that, when executed by the at least one processor, cause the apparatus at least to determine whether a multicast session or multicast service class is open to inbound roamers. The at least one memory and instructions, when executed by the at least one processor, may further cause the apparatus at least to, based on the determination, transmit a service announcement for a multicast session or service class indicating whether inbound roamers are allowed to access the multicast service or multicast service class.

In accordance with various example embodiments, an apparatus may include determining circuitry configured to perform determining whether a multicast session or multicast service class is open to inbound roamers. The apparatus may further include transmitting circuitry configured to perform, based on the determination, transmitting a service announcement for a multicast session or service class indicating whether inbound roamers are allowed to access the multicast service or multicast service class.

In accordance with some example embodiments, a method may include receiving, from a first network entity, a request for establishment of the multicast session from a second network entity. The method may further include determining, by the first network entity, whether inbound roamers are allowed to access the multicast session. The method may further include transmitting, by the first network entity, a response to the request indicating whether inbound roamers are allowed to access the multicast session.

In accordance with certain example embodiments, an apparatus may include means for receiving a request for establishment of the multicast session from a network entity. The apparatus may further include means for determining whether inbound roamers are allowed to access the multicast session. The apparatus may further include means for transmitting a response to the request indicating whether inbound roamers are allowed to access the multicast session.

In accordance with various example embodiments, a non-transitory computer readable medium may include program instructions that, when executed by an apparatus, cause the apparatus to perform at least a method. The method may include receiving a request for establishment of the multicast session from a network entity. The method may further include determining whether inbound roamers are allowed to access the multicast session. The method may further include transmitting a response to the request indicating whether inbound roamers are allowed to access the multicast session.

In accordance with some example embodiments, a computer program product may perform a method. The method may include receiving a request for establishment of the multicast session from a network entity. The method may further include determining whether inbound roamers are allowed to access the multicast session. The method may further include transmitting a response to the request indicating whether inbound roamers are allowed to access the multicast session.

In accordance with certain example embodiments, an apparatus may include at least one processor and at least one memory storing instructions that, when executed by the at least one processor, cause the apparatus at least to receive a request for establishment of the multicast session from a network entity. The at least one memory and instructions, when executed by the at least one processor, may further cause the apparatus at least to determine whether inbound roamers are allowed to access the multicast session. The at least one memory and instructions, when executed by the at least one processor, may further cause the apparatus at least to transmit a response to the request indicating whether inbound roamers are allowed to access the multicast session.

In accordance with various example embodiments, an apparatus may include receiving circuitry configured to perform receiving a request for establishment of the multicast session from a network entity. The apparatus may further include determining circuitry configured to perform determining whether inbound roamers are allowed to access the multicast session. The apparatus may further include transmitting circuitry configured to perform transmitting a response to the request indicating whether inbound roamers are allowed to access the multicast session.

In accordance with some example embodiments, a method may include receiving, by a first network entity, a request from a second network entity to establish a multicast session or service. The method may further include receiving, by the first network entity, a request from a user equipment for user service registration for the multicast service. The method may further include determining, by the first network entity, whether the user equipment is an inbound roaming user equipment. The method may further include in response to determining that the user equipment is an inbound roaming user equipment, determining whether the user equipment is allowed to access the multicast session or service. The method may further include, based upon the determination of whether the user equipment is allowed to access the multicast session or service, accepting the request from the user equipment, and providing a multicast broadcast service key to the user equipment, or rejecting the request from the user equipment.

In accordance with certain example embodiments, an apparatus may include means for receiving a request from a network entity to establish a multicast session or service. The apparatus may further include means for receiving a request from a user equipment for user service registration for the multicast service. The apparatus may further include means for determining whether the user equipment is an inbound roaming user equipment. The apparatus may further include means for, in response to determining that the user equipment is an inbound roaming user equipment, determining whether the user equipment is allowed to access the multicast session or service. The apparatus may further include means for, based upon the determination of whether the user equipment is allowed to access the multicast session or service, accepting the request from the user equipment, and providing a multicast broadcast service key to the user equipment, or rejecting the request from the user equipment.

In accordance with various example embodiments, a non-transitory computer readable medium may include program instructions that, when executed by an apparatus, cause the apparatus to perform at least a method. The method may include receiving a request from a network entity to establish a multicast session or service. The method may further include receiving a request from a user equipment for user service registration for the multicast service. The method may further include determining whether the user equipment is an inbound roaming user equipment. The method may further include, in response to determining that the user equipment is an inbound roaming user equipment, determining whether the user equipment is allowed to access the multicast session or service. The method may further include, based upon the determination of whether the user equipment is allowed to access the multicast session or service, accepting the request from the user equipment, and providing a multicast broadcast service key to the user equipment, or rejecting the request from the user equipment.

In accordance with some example embodiments, a computer program product may perform a method. The method may include receiving a request from a network entity to establish a multicast session or service. The method may further include receiving a request from a user equipment for user service registration for the multicast service. The method may further include determining whether the user equipment is an inbound roaming user equipment. The method may further include, in response to determining that the user equipment is an inbound roaming user equipment, determining whether the user equipment is allowed to access the multicast session or service. The method may further include, based upon the determination of whether the user equipment is allowed to access the multicast session or service, accepting the request from the user equipment, and providing a multicast broadcast service key to the user equipment, or rejecting the request from the user equipment.

In accordance with certain example embodiments, an apparatus may include at least one processor and at least one memory storing instructions that, when executed by the at least one processor, cause the apparatus at least to receive a request from a network entity to establish a multicast session or service. The at least one memory and instructions, when executed by the at least one processor, may further cause the apparatus at least to receive a request from a user equipment for user service registration for the multicast service. The at least one memory and instructions, when executed by the at least one processor, may further cause the apparatus at least to determine whether the user equipment is an inbound roaming user equipment. The at least one memory and instructions, when executed by the at least one processor, may further cause the apparatus at least to, in response to determining that the user equipment is an inbound roaming user equipment, determine whether the user equipment is allowed to access the multicast session or service. The at least one memory and instructions, when executed by the at least one processor, may further cause the apparatus at least to, based upon the determination of whether the user equipment is allowed to access the multicast session or service, accept the request from the user equipment, and provide a multicast broadcast service key to the user equipment, or reject the request from the user equipment.

In accordance with various example embodiments, an apparatus may include receiving circuitry configured to perform receive a request from a network entity to establish a multicast session or service. The apparatus may further include receiving circuitry configured to perform receiving a request from a user equipment for user service registration for the multicast service. The apparatus may further include determining circuitry configured to perform determining whether the user equipment is an inbound roaming user equipment. The apparatus may further include determining circuitry configured to perform, in response to determining that the user equipment is an inbound roaming user equipment, determining whether the user equipment is allowed to access the multicast session or service. The apparatus may further include accepting or rejecting circuitry configured to perform, based upon the determination of whether the user equipment is allowed to access the multicast session or service, accepting the request from the user equipment, and provide a multicast broadcast service key to the user equipment, or reject the requesting from the user equipment.

In accordance with some example embodiments, a method may include storing, by a network entity, user equipment multicast service subscription data of a user equipment comprising at least one of: an indication whether the user equipment is authorized to access multicast services while roaming, an identity of visited PLMN where the user equipment is authorized to access multicast services while roaming, an identity of visited PLMN where the user equipment is not authorized to access multicast services while roaming, a multicast service classes that the user equipment is authorized to access while roaming, or a multicast service classes that the user equipment is not authorized to access while roaming. The method may further include receiving, by the network entity, a query or subscription for the user equipment multicast service subscription data of the user equipment. The method may further include providing, by the network entity, in response to the query or subscription the user equipment multicast service subscription data of the user equipment.

In accordance with certain example embodiments, an apparatus may include means for storing user equipment multicast service subscription data of a user equipment comprising at least one of: an indication whether the user equipment is authorized to access multicast services while roaming, an identity of visited PLMN where the user equipment is authorized to access multicast services while roaming, an identity of visited PLMN where the user equipment is not authorized to access multicast services while roaming, a multicast service classes that the user equipment is authorized to access while roaming, or a multicast service classes that the user equipment is not authorized to access while roaming. The apparatus may further include means for receiving a query or subscription for the user equipment multicast service subscription data of the user equipment. The apparatus may further include means for providing in response to the query or subscription the user equipment multicast service subscription data of the user equipment.

In accordance with various example embodiments, a non-transitory computer readable medium may include program instructions that, when executed by an apparatus, cause the apparatus to perform at least a method. The method may include storing user equipment multicast service subscription data of a user equipment comprising at least one of: an indication whether the user equipment is authorized to access multicast services while roaming, an identity of visited PLMN where the user equipment is authorized to access multicast services while roaming, an identity of visited PLMN where the user equipment is not authorized to access multicast services while roaming, a multicast service classes that the user equipment is authorized to access while roaming, or a multicast service classes that the user equipment is not authorized to access while roaming. The method may further include receiving a query or subscription for the user equipment multicast service subscription data of the user equipment. The method may further include providing in response to the query or subscription the user equipment multicast service subscription data of the user equipment.

In accordance with some example embodiments, a computer program product may perform a method. The method may include storing user equipment multicast service subscription data of a user equipment comprising at least one of: an indication whether the user equipment is authorized to access multicast services while roaming, an identity of visited PLMN where the user equipment is authorized to access multicast services while roaming, an identity of visited PLMN where the user equipment is not authorized to access multicast services while roaming, a multicast service classes that the user equipment is authorized to access while roaming, or a multicast service classes that the user equipment is not authorized to access while roaming. The method may further include receiving a query or subscription for the user equipment multicast service subscription data of the user equipment. The method may further include providing in response to the query or subscription the user equipment multicast service subscription data of the user equipment.

In accordance with certain example embodiments, an apparatus may include at least one processor and at least one memory storing instructions that, when executed by the at least one processor, cause the apparatus at least to store user equipment multicast service subscription data of a user equipment comprising at least one of: an indication whether the user equipment is authorized to access multicast services while roaming, an identity of visited PLMN where the user equipment is authorized to access multicast services while roaming, an identity of visited PLMN where the user equipment is not authorized to access multicast services while roaming, a multicast service classes that the user equipment is authorized to access while roaming, or a multicast service classes that the user equipment is not authorized to access while roaming. The at least one memory and instructions, when executed by the at least one processor, may further cause the apparatus at least to receive a query or subscription for the user equipment multicast service subscription data of the user equipment. The at least one memory and instructions, when executed by the at least one processor, may further cause the apparatus at least to provide in response to the query or subscription the user equipment multicast service subscription data of the user equipment.

In accordance with various example embodiments, an apparatus may include storing circuitry configured to perform storing user equipment multicast service subscription data of a user equipment comprising at least one of: an indication whether the user equipment is authorized to access multicast services while roaming, an identity of visited PLMN where the user equipment is authorized to access multicast services while roaming, an identity of visited PLMN where the user equipment is not authorized to access multicast services while roaming, a multicast service classes that the user equipment is authorized to access while roaming, or a multicast service classes that the user equipment is not authorized to access while roaming. The apparatus may further include receiving circuitry configured to perform receiving a query or subscription for the user equipment multicast service subscription data of the user equipment. The apparatus may further include providing circuitry configured to perform providing in response to the query or subscription the user equipment multicast service subscription data of the user equipment.

### BRIEF DESCRIPTION OF THE DRA WINGS

For a proper understanding of example embodiments, reference should be made to the accompanying drawings, wherein:

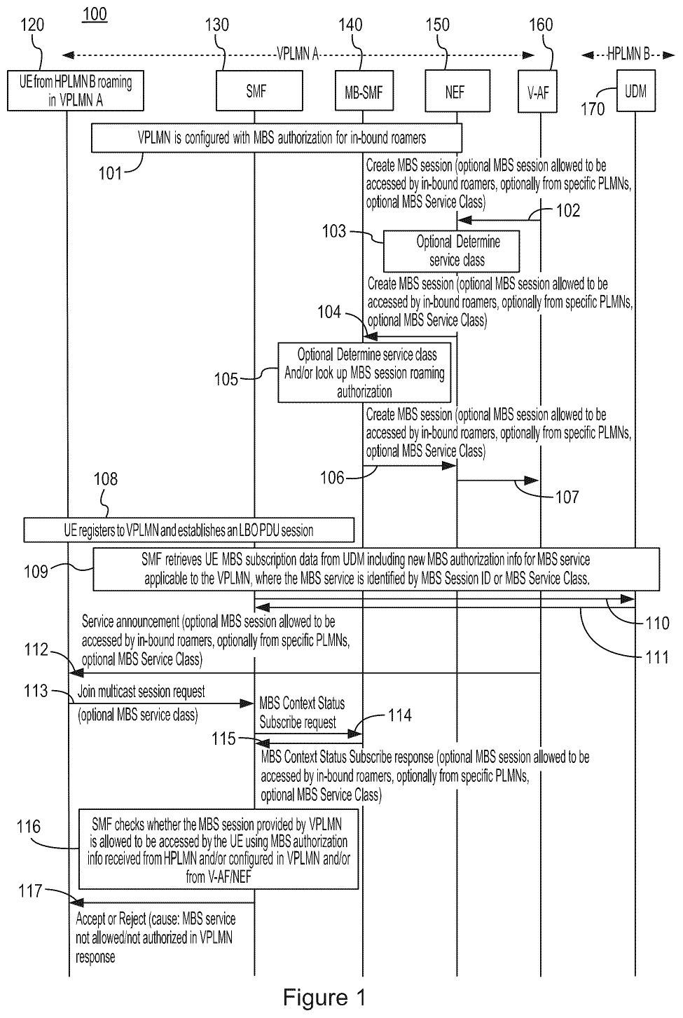

FIG. 1 illustrates an example of a signaling diagram for multicast MBS service authorization for inbound and outbound roaming UEs according to certain example embodiments;

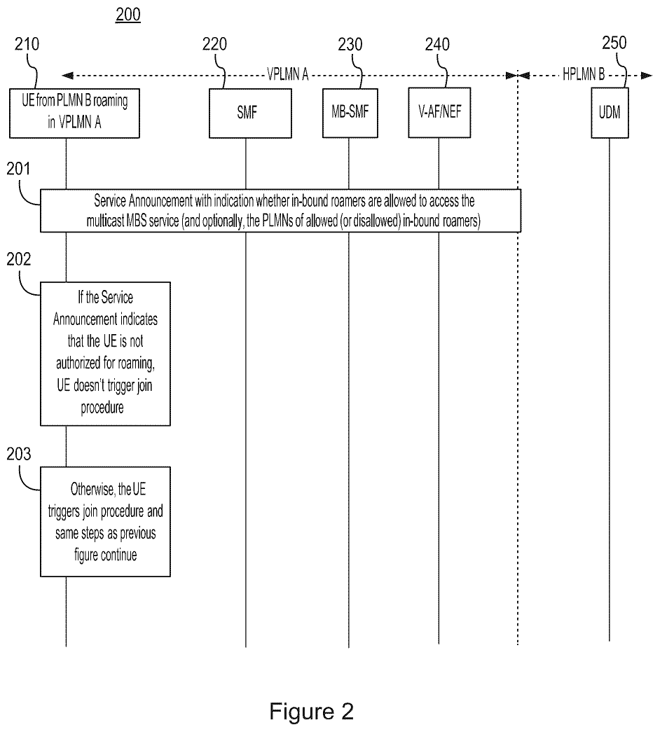

FIG. 2 illustrates an example of a signaling diagram for multicast MBS service authorization for inbound roaming UEs with service announcement indicating whether inbound roamers are allowed to access the MBS service according to certain example embodiments;

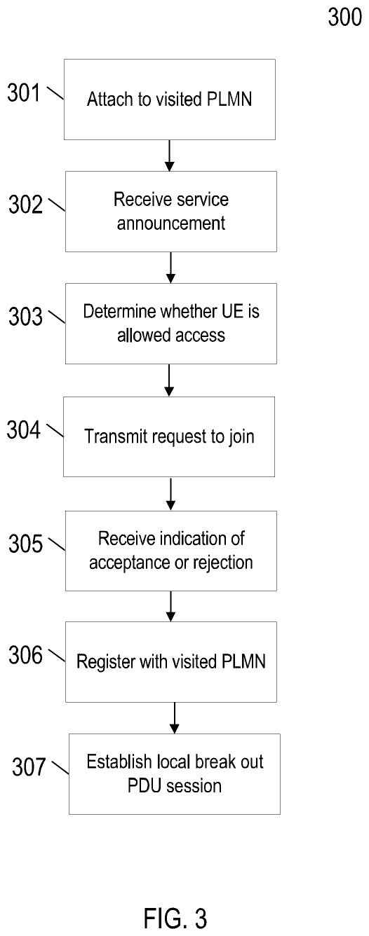

FIG. 3 illustrates an example of a flow diagram of a method according to certain example embodiments;

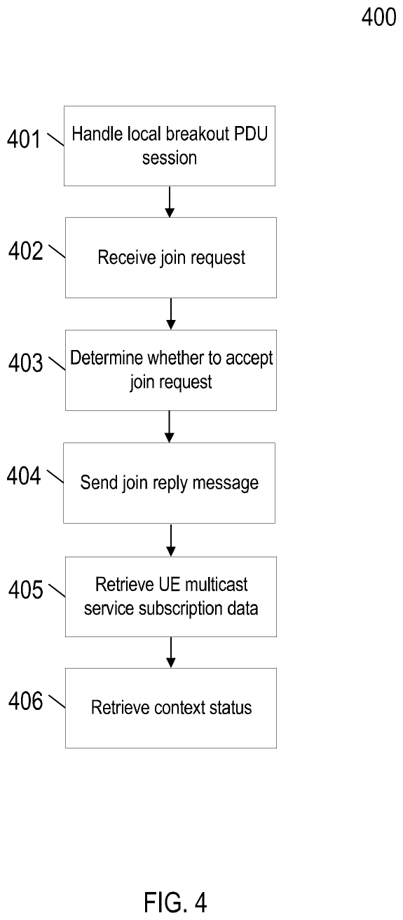

FIG. 4 illustrates an example of a flow diagram of a method according to some example embodiments;

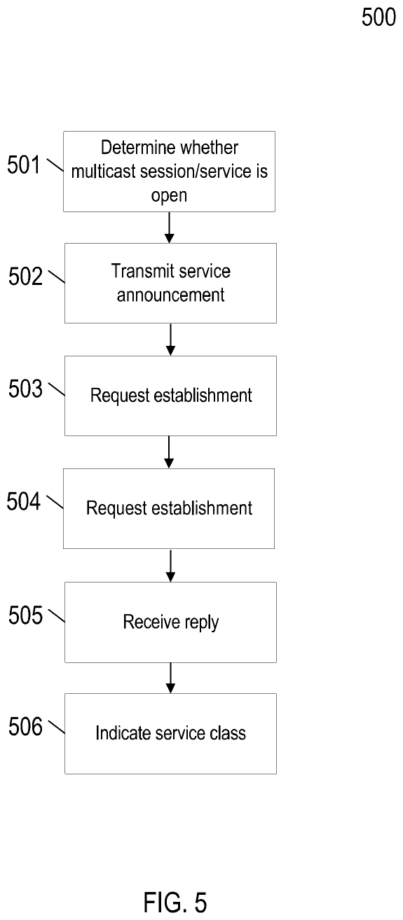

FIG. 5 illustrates an example of a flow diagram of a method according to various example embodiments;

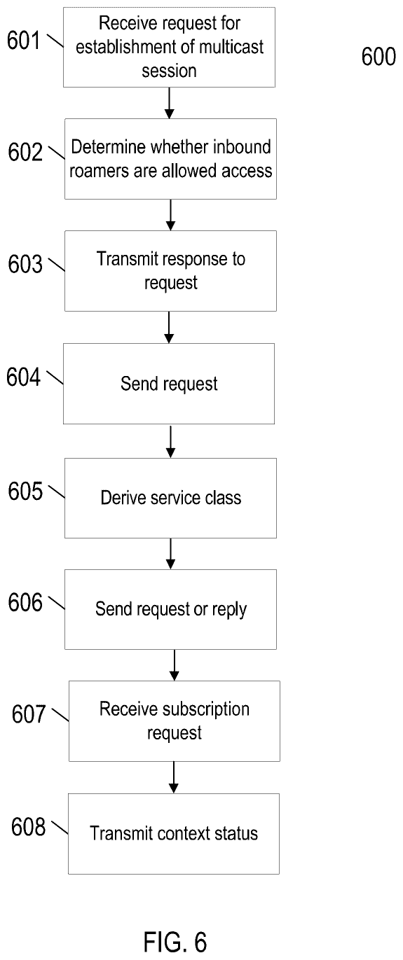

FIG. 6 illustrates an example of a flow diagram of a method according to certain example embodiments;

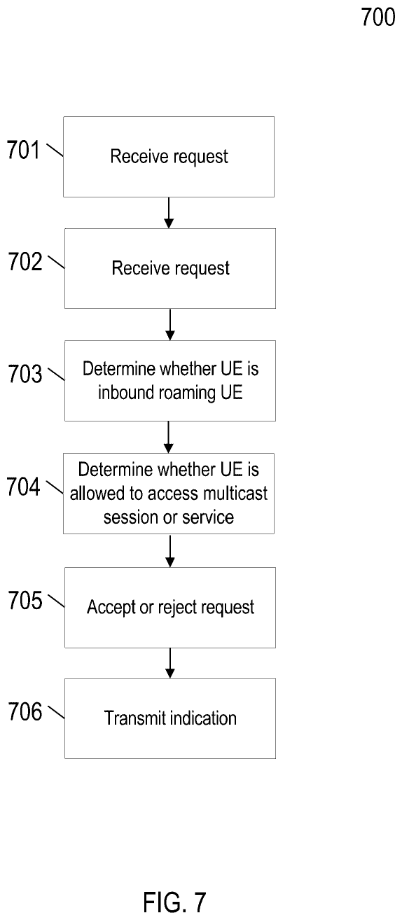

FIG. 7 illustrates an example of a flow diagram of a method according to some example embodiments;

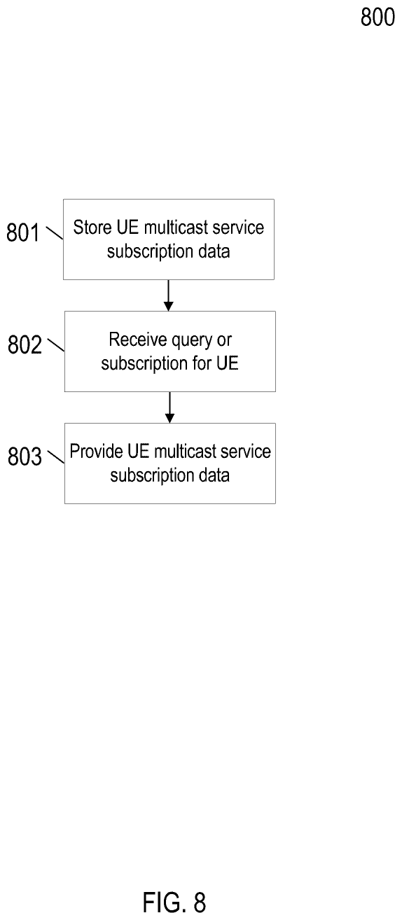

FIG. 8 illustrates an example of a flow diagram of a method according to various example embodiments;

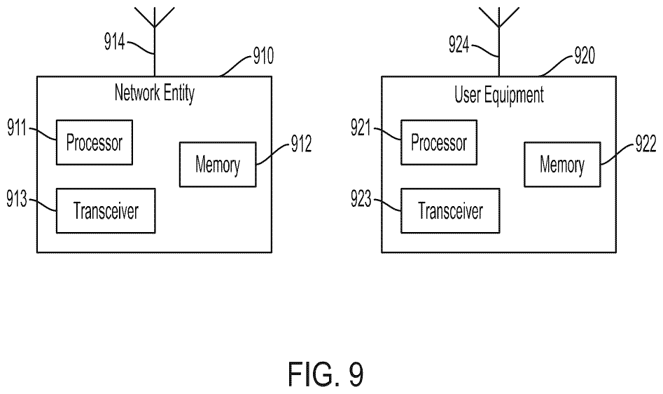

FIG. 9 illustrates an example of various network devices according to some example embodiments; and

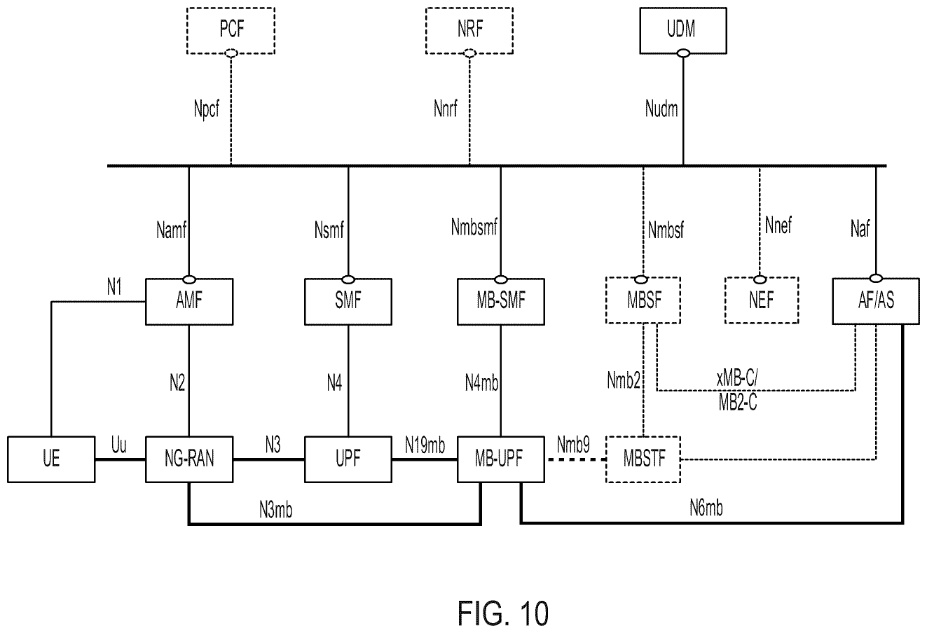

FIG. 10 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for roaming of multicast MBS services is not intended to limit the scope of certain example embodiments, but is instead representative of selected example embodiments.

In general, MBS services may enable communication to a plurality of user equipment. However, roaming is currently unsupported for multicast MBS services. There is a need for a visited public land mobile network (VPLMN) and/or visited public land mobile network application function (V-AF) to allow or disallow multicast MBS services to inbound roamers, such as for services provided locally in the VPLMN (e.g., local tourist information) and/or in the VPLMN from a same service class as subscribed by the user in the HPLMN (e.g., weather forecast). Furthermore, there is a need for HPLMNs to allow or disallow multicast MBS services to outbound roamers, such as for services provided in the VPLMN (e.g., from a same service class as subscribed by the user in the HPLMN such as weather forecast).

Certain example embodiments described herein may have various benefits and/or advantages to overcome the disadvantages described above. For example, certain example embodiments may enable the HPLMN operator to allow or disallow all or specific multicast MBS services when the UE is (outband) roaming in a VPLMN, and may enable the VPLMN operator to allow or disallow all or specific multicast MBS services to UEs (inbound) roaming in the VPLMN. Furthermore, some example embodiments may enable the V-AF to allow or disallow a specific multicast MBS service to UEs (inbound) roaming in the VPLMN. In addition, multicast MBS services may be identified by an MBS service class, thus allowing different TMGIs or source specific multicast address to be used in HPLMN and each VPLMN. Various example embodiments may also conserve signaling by preventing the UE to unnecessarily try to join a multicast MBS session and then get rejected due to not being authorized for roaming. Thus, certain example embodiments discussed below are directed to improvements in computer-related technology.

Although the description below is provided using a PLMN, any of these example embodiments can be applied using a SNPN instead. In certain example embodiments, a VPLMN may be configured with authorization information indicating whether a multicast MBS service provided by the VPLMN is allowed to be accessed by inbound roamers of all or some particular HPLMNs with which the VPLMN operator has roaming/SLA agreements. An MBS service authorization configured in the VPLMN may be associated with an MBS Session ID (e.g., TMGI or source specific IP multicast address), with an MBS service class (e.g., weather forecast), and/or may apply to all MBS services provided by the VPLMN that are not restricted to specific users. In addition, the VPLMN MBS service authorization information may be configured in the MB-SMF of the VPLMN, in SMFs of the VPLMN, and/or in a database of the VPLMN.

During the establishment of a multicast MBS session, the AF attached to the VPLMN (V-AF) may indicate to the NEF/MB-SMF whether the MBS session is open to (i.e., allowed to be accessed by) inbound roamers from all or specific HPLMNs and/or it may provide the MBS service class of the MBS service. Alternatively, the NEF may be configured with a mapping of AF IDs and/or MBS session IDs to service classes, and/or may add the service class when forwarding an MBS session establishment request to the MB-SMF. Furthermore, the mapping of MBS session IDs to service classes may be configured in a database of the VPLMN, and looked up by the NEF, MB-SMF, and/or SMF in the VPLMN.

In the response to the MBS session establishment request, the MB-SMF/NEF may provide the service class to the NEF/AF. The NEF or MB-SMF may also indicate, in the response to the establishment of an MBS session, whether inbound roamers are allowed to access the multicast MBS service, possibly with the PLMNs of allowed (or disallowed) inbound roamers.

The service announcement from the V-AF (or from the MBSF/MBSTF) may indicate whether inbound roamers are allowed to access the multicast MBS service, possibly with the PLMNs of allowed (or disallowed) inbound roamers, and/or the service class of the MBS service. The service announcement may only be provided by the V-AF to a roaming user if the roaming user is authorized to use the service. The AF attached to the VPLMN may be configured with MBS service class and/or authorization information, or it may obtain the authorization from the VPLMN when requesting the establishment of an MBS broadcast session as described above. If the V-AF encrypts the broadcast data it provides, it may only provide keys enabling the description to roaming users which are authorized to use the service. In addition, the UE may be configured with information about MBS service classes that it can access when roaming, possibly related to specific VPLMNs.

The UE MBS subscription in UDM (e.g., HPLMN) may be extended with new roaming authorization information indicating whether the UE is allowed to access specific multicast MBS services, specific MBS service classes, or all MBS services when the UE is roaming. The new authorization information may apply either to specific VPLMNs stored as part of the UE MBS subscription information, or to any VPLMN (if no specific VPLMNs are stored). Different specific MBS services or specific MBS service classes may be authorized for different VPLMNs.

MBS service authorizations configured in user subscription may be associated with a list of MBS session ID(s) (e.g., TMGI or source specific IP multicast address), and/or with an MBS service class (e.g., weather forecast).

When the UE requests to join an MBS session, the UE may indicate the service class in addition to, or instead of, the MBS session ID.

SMF in VPLMN may authorize an inbound roamer requesting to join a multicast MBS service provided in the VPLMN taking into account the VPLMN, and/or HPLMN MBS service authorization information, and, if available, the MBS service class of the multicast MBS service. The SMF may request the UE MBS subscription information containing the new roaming authorization information from the UDM in the HPLMN. The SMF may obtain the information about the MBS service class for the MBS service and/or VPLMN MBS service authorization information from the MB-SMF handling the MBS service when requesting information about the MBS multicast service, and/or the SMF may obtain the VPLMN MBS service authorization information from a database.

When the roaming UE requests to join a multicast MBS session in the VPLMN and the SMF finds that the UE is not authorized as described above, the UE request may be rejected by SMF with a new cause indicating that access to the MBS service is not allowed/authorized in VPLMN.

FIG. 1 illustrates an example of a signaling diagram 100 depicting multicast MBS service authorization for inbound and outbound roaming UEs. UE 120 may be similar to UE 920, and SMF 130, MB-SMF 140, NEF 150, V-AF 160, and UDM 170 may be similar to NE 910, as illustrated in FIG. 9, according to certain example embodiments.

In general, UE 120 may establish a local break out (LBO) PDU session, and request to join the multicast MBS session to access a multicast MBS service provided in the VPLMN. Call flows to establish an LBO PDU session and a multicast MBS session in the VPLMN may be predefined, as well as for UE 120 to join the multicast MBS service in the VPLMN for non-roaming operations. This may include the AMF, SMF 130, MB-SMF 140, AF (not shown), NEF 150, and/or MBSF (not shown) being located in the VPLMN and UDM 170 in the HPLMN.

At operation 101, the VPLMN (i.e., SMF 130, MB-SMF 140, NEF 150) may be configured with authorization information for multicast MBS services for inbound roamers. In particular, the VPLMN may be configured with authorization information indicating whether a multicast MBS service provided by the VPLMN is allowed to be accessed by inbound roamers of all or of certain HPLMNs with which the VPLMN operator has roaming/SLA agreements. This authorization information may be configured in the VPLMN (e.g., at SMF 130, MB-SMF 140, and/or in a database (e.g., V-UDR or V-UDM for non-subscriber related information)).

The MBS service authorization configured in VPLMN may be associated with an MBS session ID (e.g., TMGI or source specific IP multicast address) or with an MBS service class (e.g., weather forecast). In addition, there may be a default configuration for all multicast MBS services not explicitly configured above (e.g., a default rejection/acceptance). The VPLMN multicast MBS service authorization information may be configured at MB-SMF 140 of the VPLMN, in SMFs of the VPLMN, or in a database of the VPLMN.

At operation 102, V-AF 160 may provide service class and/or multicast MBS service authorization information to NEF 150 for inbound roamers when establishing (or modifying) a multicast MBS session. For example, when establishing (or modifying) a multicast MBS session, V-AF 160 (or NEF 150/MB-SMF 140 in VPLMN) may indicate to NEF 150/MB-SMF 140 whether the MBS session is open to (i.e., allowed to be accessed by) inbound roamers from all or specific HPLMNs, and/or may also provide the MBS service class of the MBS service.

At optional operation 103, the VPLMN (i.e., NEF 150) may derive service class when handling the request to establish MBS session and/or when handling an MBS session join request. Alternatively, NEF 150 may be configured with a mapping of AF IDs or MBS session IDs to service classes, and may add the service class when forwarding an MBS session establishment request to MB-SMF 140. In various example embodiments, the mapping may be configured in MB-SMF 140. In certain example embodiments, the mapping of MBS session IDs to service classes is configured in a database of the VPLMN and looked up by NEF 150, MB-SMF 140, or SMF 130 in the VPLMN.

At operation 104, V-AF 160 may transmit a Create MBS session request to MB-SMF 140, which may include an optional MBS session allowed to be accessed by inbound roamers, optionally from specific PLMNs, and/or optional MBS service class. In particular, V-AF 160 may provide service class and/or VPLMN multicast MBS service authorization information in the service announcement. The service announcement from V-AF 160 may indicate whether inbound roamers are allowed to access the multicast MBS service, possibly with the PLMNs of allowed (or disallowed) inbound roamers, and/or the service class of the MBS service. The MBS service announcement may indicate the service class and/or whether inbound roamers are allowed (or disallowed) to access the multicast MBS service, optionally with the HPLMN IDs of allowed (or disallowed) inbound roamers. Inbound roaming UEs may use this information to determine whether they can access the multicast MBS service provided by the VPLMN, and accordingly, whether they can request to join the multicast MBS service. The MBS service announcement may alternatively indicate whether inbound roamers are allowed (or disallowed) to access the MBS service class corresponding to this multicast MBS service, optionally with the HPLMN IDs of allowed (or disallowed) inbound roamers for this MBS service class.

In various example embodiments, V-AF 160 may derive this information from configuration, or MB-SMF 140/NEF 150 may provide this information in the response to the MBS session establishment request to V-AF 160. If an MBSF is deployed in the VPLMN, the service announcement may be provided by the MBSF, including the authorization information, as described above, that may be obtained from V-AF 160 or from MB-SMF 140.

At optional operation 105, MB-SMF 140 may determine a service class and/or look up an MBS session roaming authorization. For example, VPLMN (i.e., MB-SMF 140) may determine whether a multicast MBS service can be accessed by inbound roamers from other HPLMNs by determining whether the MBS service is allowed to be accessed by inbound roamers, and if so, for inbound roamers from all HPLMNs or from specific HPLMNs, considering the VPLMN authorization information configured in the VPLMN (at operation 101) and/or the authorization information received from the V-AF for the multicast MBS service (at operation 102). Based on operator policy, when both information is available, the multicast MBS service may be accessed by UEs from HPLMNs that are either allowed by the VPLMN or by V-AF 160, or that are allowed by both the VPLMN and V-AF 160.

At operations 106 and 107, MB-SMF 140 may transmit to NEF 150 and V-AF 160, respectively, a create MBS session request, which may include optional MBS session allowed to be accessed by inbound roamers, optionally from specific PLMNs, and/or optional MBS service class.

When SMF 130 subscribes to an multicast MBS session context status to MB-SMF 140 (when UE 120 requests to join a multicast MBS session, see step 3b of FIG. 1), MB-SMF 140 may indicate in the response to SMF 130 the MBS service class and/or whether the multicast MBS session can be accessed by inbound roamers from all or from specific HPLMNs or whether the MBS service class corresponding to this multicast MBS session can be accessed by inbound roamers from all or from specific HPLMNs. Alternatively, SMF 130 may look up the VPLMN MBS session authorization information from a database based on the MBS service class or the MBS session ID.

When an inbound roaming UE requests to join an MBS session, SMF 130 (in VPLMN) may check whether the multicast MBS service provided by the VPLMN is allowed to be accessed by UE 120, as defined in 3.

At operation 108, UE 120 may register to VPLMN and establish an LBO PDU session. Specifically, a UE MBS subscription in UDM may be extended with new authorization information indicating whether UE 120 is allowed to access specific multicast MBS services, specific multicast MBS service classes, or all multicast MBS services when UE 120 is roaming, optionally with a list of VPLMNs in which this is allowed (or disallowed). The new authorization information may also alternatively indicate a list of multicast MBS services or multicast MBS service classes which are not allowed when the UE is roaming, optionally with a list of VPLMNs where they are not allowed.

The MBS service authorization in the subscription may be associated with an MBS Session ID (e.g., TMGI or source specific IP multicast address) or with an MBS service class (e.g., weather forecast).

When the UE is roaming, at operation 110, SMF 130 in the VPLMN may retrieves the HPLMN MBS authorization info from UDM 170, and at operation 111, UDM 170 may indicate back to SMF 130 whether the UE MBS subscription allows the multicast MBS session provided by the VPLMN to be accessed by UE 120. UE 120 may have already received a service announcement in its HPLMN including the list of unauthorized MBS services, MBS service classes when roaming, and optionally unauthorized VPLMNs, and accordingly may refrain from sending a request to join the MBS session when roaming in these unauthorized VPLMNs.

At operation 112, V-AF 160 may transmit a service announcement to UE 120, which may include optional MBS session allowed to be accessed by inbound roamers, optionally from specific PLMNs, and/or optional MBS service class.

At operation 113, UE 120 may transmit to SMF 130 a request to join a multicast session, which may include an optional MBS service class.

At operation 114, SMF 130 may transmit to MB-SMF 140 an MBS context status subscribe request.

At operation 115, MB-SMF 140 may transmit to SMF 130 an MBS context status subscribe response, which may include an optional MBS session allowed to be accessed by inbound roamers, optionally from specific PLMNs, and optional MBS service class.

At operation 116, SMF 160 may check whether the multicast MBS service provided by the VPLMN is allowed to be accessed by inbound roamers from the HPLMN of the UE, and that the user's subscription received from the HPLMN (UDM) allows the UE to access the multicast MBS service in the VPLMN.

At operation 117, SMF 130 may transmit to UE 120 an accept or reject, which may indicate a cause, such as MBS service not allowed/not authorized in VPLMN response. If the VPLMN and/or V-AF 160 allows the multicast MBS service to be accessed by the UE 120 HPLMN, and if the user subscription received from the HPLMN allows the user to access the multicast MBS service in the VPLMN, UE 120 may be accepted to join the multicast service. Otherwise, the UE request may be rejected with a new cause indicating that access to the MBS service (or MBS service class) is not allowed/authorized in VPLMN (the cause may further differentiate whether the rejection is due to the VPLMN or HPLMN disallowing access to the MBS service or service class in the VPLMN).

FIG. 2 illustrates an example of a signaling diagram 200 for multicast MBS service authorization for inbound roaming UEs with service announcement indicating whether inbound roamers are allowed to access the MBS service. UE 210 may be similar to UE 920, and SMF 220, MB-SMF 230, NEF 150, V-AF/NEF 240, and UDM 250 may be similar to NE 910, as illustrated in FIG. 9, according to certain example embodiments.

At operation 201, UE 210 may transmit a service announcement with an indication of whether inbound roamers are allowed to access the multicast MBS service (and optionally, the PLMNs of allowed (or disallowed) inbound roamers).

At operation 202, if the service announcement indicates that UE 210 is not authorized for roaming, UE 210 may not trigger a join procedure.

However, at operation 203, UE may trigger a join procedure and procedure with the procedure described in FIG. 1.

FIG. 3 illustrates an example of a flow diagram of a method 300 that may be performed by a UE, such as UE 920 illustrated in FIG. 9, according to various example embodiments.

At step 301, the method may include attaching, by a user equipment, to a visited PLMN as inbound roamer.

At step 302, the method may further include receiving, by the user equipment, from an application function, a service announcement comprising at least one of a multicast service session allowed to be accessed by inbound roamers indication or multicast service class. The service announcement may indicate at least one PLMN of allowed or disallowed inbound roamers.

At step 303, the method may further include determining, by the user equipment, based on the service announcement, whether the user equipment is allowed to access a multicast session or multicast service class in the visited PLMN.

At step 304, the method may further include transmitting, by the user equipment, in response to determining that the user equipment is allowed to access, a request to join a multicast session comprising an identifier of the multicast session and/or a multicast service class.

At step 305, the method may further include receiving, by the user equipment, an indication of an acceptance or rejection of the request to join the multicast session. The indication of rejection of the request to join the multicast session may include an indication that access to the multicast session is not permitted for an inbound roamer.

At step 306, the method may further include registering, by the user equipment, with the visited PLMN.

At step 307, the method may further include establishing a local break out protocol data unit session.

FIG. 4 illustrates an example of a flow diagram of a method 400 that may be performed by a NE, such as NE 910 illustrated in FIG. 9, according to various example embodiments.

At step 401, the method may include handling, by a network entity, a local breakout packet data unit session for an inbound roamer user equipment.

At step 402, the method may further include receiving, by the network entity, a join request of the inbound roamer user equipment for a multicast service session or a multicast service class.

At step 403, the method may further include determining, based on multicast roaming authorization information for the multicast service session or a multicast service class and/or the inbound roamer, whether to accept the join request.

At step 404, the method may further include sending a join reply message indicating whether the join request is accepted or rejected.

At step 405, the method may further include retrieving, by the network entity, user equipment multicast service subscription data from a unified data manager comprising at least one of an indication whether the user equipment is authorized to access multicast services while roaming, and identities of visited PLMN where the user equipment is authorized to access multicast services while roaming, and identities of visited PLMN where the user equipment is not authorized to access multicast services while roaming; and multicast service classes that the user equipment is authorized to access while roaming, and multicast service classes that the user equipment is not authorized to access while roaming. The user equipment multicast service subscription data may be used in determining whether to accept the join request.

At step 406, the method may further include retrieving, by the network entity, information about the context status of the multicast service session or multicast service class from a multicast session management function comprising at least one of: an indication whether the multicast service session or multicast service class is allowed to be accessed by inbound roaming user equipment, and identities of home PLMN of inbound roaming user equipment authorized to access multicast service session or multicast service class, and identities of home PLMN of inbound roaming user equipment not authorized to access multicast service session or multicast service class, and the multicast service class for the multicast service session. The user equipment multicast service subscription data may be used in determining whether to accept the join request. The join reply message may indicate that the join request is rejected comprises an error cause indicating that access to the multicast service session or multicast service class is not permitted for an inbound roamer.

FIG. 5 illustrates an example of a flow diagram of a method 500 that may be performed by a NE, such as NE 910 illustrated in FIG. 9, according to various example embodiments.

At step 501, the method may include determining, by a network entity, whether a multicast session or multicast service class is open to inbound roamers. The determination may be based on configured information.

At step 502, the method may further include, based on the determination, transmitting, by a network entity, a service announcement for a multicast session or service class indicating whether inbound roamers are allowed to access the multicast service or multicast service class. The service announcement may further indicate at least one home PLMN of allowed or disallowed inbound roamers.

At step 503, the method may further include requesting the establishment of the multicast service from a second network entity and indicating in the request whether inbound roamers are allowed to access the multicast service.

At step 504, the method may further include requesting the establishment of the multicast session from a second network entity.

At step 505, the method may further include receiving a reply to the request comprising at least one of a second indication whether inbound roamers are allowed to access the multicast session, identities of home PLMN of inbound roaming user equipment authorized to access multicast service session, and identities of home PLMN of inbound roaming user equipment not authorized to access multicast service session. The determining may be based on the second indication.

At step 506, the method may further include indicating the service class in the request for establishment of the multicast session.

FIG. 6 illustrates an example of a flow diagram of a method 600 that may be performed by a NE, such as NE 910 illustrated in FIG. 9, according to various example embodiments.

At step 601, the method may include receiving, by a first network entity, a request for establishment of the multicast session from a second network entity. The request for the establishment of the multicast session may include a multicast service class.

At step 602, the method may further include determining, by the first network entity, whether inbound roamers are allowed to access the multicast session. The determining may be based on at least one of an identity of the second network entity, the multicast service class, configured information, or information obtained from a database.

At step 603, the method may further include transmitting, by the first network entity, a response to the request indicating whether inbound roamers are allowed to access the multicast session.

At step 604, the method may further include sending a request for the establishment of the multicast session, wherein the request comprises an indication whether inbound roamers are allowed to access the multicast service.

At step 605, the method may further include deriving, by the first network entity, a service class for the multicast session based on configured information related to a service class for the second network entity and/or a service class for the identifier of the multicast session and/or a default service class.

At step 606, the method may further include sending, by the first network entity, either a request for the establishment of the multicast session or a reply to the request for the establishment of the multicast session, wherein the request or the reply comprises the service class.

At step 607, the method may further include receiving, by the first network entity, a subscription request for the context status of the multicast service session or multicast service class from a session management function.

At step 608, the method may further include transmitting, by the first network entity, context status of the multicast service session or multicast service class, comprising at least one of: an indication whether the multicast service session or multicast service class is allowed to be accessed by inbound roaming user equipment, and identities of home PLMN of inbound roaming user equipment authorized to access multicast service session or multicast service class, and identities of home PLMN of inbound roaming user equipment not authorized to access multicast service session or multicast service class, and the multicast service class for the multicast service session.

FIG. 7 illustrates an example of a flow diagram of a method 700 that may be performed by a NE or UE, such as NE 910 or UE 920 illustrated in FIG. 9, according to various example embodiments.

At step 701, the method may include receiving, by a first network entity, a request from a second network entity to establish a multicast session or service.

At step 702, the method may further include receiving, by the first network entity, a request from a user equipment for user service registration for the multicast service.

At step 703, the method may further include determining, by the first network entity, whether the user equipment is an inbound roaming user equipment.

At step 704, the method may further include, in response to determining that the user equipment is an inbound roaming user equipment, determining whether the user equipment is allowed to access the multicast session or service.

In some example embodiments, the determining may be based upon at least one of an identity of the second network entity, a home public land mobile network of the user equipment, roaming restriction information for the multicast session or service received within the request for the establishment of the multicast session or service, a service class received in the request for the establishment of the multicast session or service, configured roaming restriction information for the at least one service class, the at least one multicast session or service, or at least one home public land mobile network retrieved from a database, or roaming restriction information for the at least one service class, at least one multicast session or service, or at least one home public land mobile network.

At step 705, the method may further include based upon the determination of whether the user equipment is allowed to access the multicast session or service, accepting the request from the user equipment, and providing a multicast broadcast service key to the user equipment, or rejecting the request from the user equipment. For example, the accepting may include providing an MBS service key to the user equipment. In various example embodiments, the rejection of the request of the user equipment may include at least a cause value configuring the user equipment to cease retrying the user service registration for the multicast service.

At step 706, the method may further include transmitting an indication to the user equipment configuring the user equipment to cease retrying the user service registration for the multicast and an MBS service key.

FIG. 8 illustrates an example of a flow diagram of a method 800 that may be performed by a NE, such as NE 910 illustrated in FIG. 9, according to various example embodiments.

At step 801, the method may include storing, by a network entity, user equipment multicast service subscription data of a user equipment comprising at least one of: an indication whether the user equipment is authorized to access multicast services while roaming, an identity of visited PLMN where the user equipment is authorized to access multicast services while roaming, an identity of visited PLMN where the user equipment is not authorized to access multicast services while roaming, a multicast service classes that the user equipment is authorized to access while roaming, or a multicast service classes that the user equipment is not authorized to access while roaming.

At step 802, the method may further include receiving, by the network entity, a query or subscription for the user equipment multicast service subscription data of the user equipment.

At step 803, the method may further include providing, by the network entity, in response to the query or subscription, the user equipment multicast service subscription data of the user equipment.

FIG. 9 illustrates an example of a system according to certain example embodiments. In one example embodiment, a system may include multiple devices, such as, for example, NE 910 and/or UE 920.

NE 910 may be one or more of a base station (e.g., 3G UMTS NodeB, 4G LTE Evolved NodeB, or 5G NR Next Generation NodeB), a serving gateway, a server, and/or any other access node or combination thereof.

NE 910 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5th generation core (5GC).

UE 920 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 910 and/or UE 920 may be one or more of a citizens broadband radio service device (CBSD).

NE 910 and/or UE 920 may include at least one processor, respectively indicated as 911 and 921. Processors 911 and 921 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 912 and 922. The memory may be fixed or removable. The memory may include computer program instructions or computer code contained therein. Memories 912 and 922 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 911 and 921, memories 912 and 922, and any subset thereof, may be configured to provide means corresponding to the various blocks of FIGS. 1-8. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 9, transceivers 913 and 923 may be provided, and one or more devices may also include at least one antenna, respectively illustrated as 914 and 924. The device may have many antennas, such as an array of antennas configured for multiple input multiple output (MIMO) communications, or multiple antennas for multiple RATs. Other configurations of these devices, for example, may be provided. Transceivers 913 and 923 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-8). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-8. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

FIG. 10 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 10 may be similar to NE 910 and UE 920, respectively. The user plane function (UPF) may provide services such as intra-RAT and inter-RAT mobility, routing and forwarding of data packets, inspection of packets, user plane quality of service (QOS) processing, buffering of downlink packets, and/or triggering of downlink data notifications. The application function (AF) may primarily interface with the core network to facilitate application usage of traffic routing and interact with the policy framework.

According to certain example embodiments, processors 911 and 921, and memories 912 and 922, may be included in or may form a part of processing circuitry or control circuitry. In addition, in some example embodiments, transceivers 913 and 923 may be included in or may form a part of transceiving circuitry.

In some example embodiments, an apparatus (e.g., NE 910 and/or UE 920) may include means for performing a method, a process, or any of the variants discussed herein. Examples of the means may include one or more processors, memory, controllers, transmitters, receivers, and/or computer program code for causing the performance of the operations.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP 3^{rd} Generation Partnership Project
5G 5^{th} Generation
5GC 5^{th} Generation Core
6G 6^{th} Generation
AF Application Function
AMF Access and Mobility Management Function
ASIC Application Specific Integrated Circuit
CBSD Citizens Broadband Radio Service Device
CPU Central Processing Unit
CU Centralized Unit
DU Distributed Unit
eMBB Enhanced Mobile Broadband
eNB Evolved Node B
gNB Next Generation Node B
GPS Global Positioning System
HDD Hard Disk Drive
HPLMN Home Public Land Mobile Network
IoT Internet of Things
LBO Local Break Out
LTE Long-Term Evolution
LTE-A Long-Term Evolution Advanced
MBS Multicast/Broadcast Service
MBSF Multicast/Broadcast Service Function
MBSTF Multicast/Broadcast Service Transport Function
MB-SMF Multicast/Broadcast Session Management Function
MEMS Micro Electrical Mechanical System
MIMO Multiple Input Multiple Output
mMTC Massive Machine Type Communication
NE Network Entity
NEF Network Exposure Function
NG Next Generation
NG-eNB
NG-RAN
NR
PDA
PDU
Next Generation Evolved Node B
Next Generation Radio Access Network
New Radio
Personal Digital Assistance
Protocol Data Unit
PLMN Public Land Mobile Network
QOS Quality of Service
RAM Random Access Memory
RAN Radio Access Network
RAT Radio Access Technology
RF Radio Frequency
ROM Read-Only Memory
SLA Service Level Agreement
SMF Session Management Function
SNPN Standalone Non-Public Network
TMGI Temporary Mobile Group Identity
UDM Unified Data Manager
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network
V-AF Visited Public Land Mobile Network Application Function
VPLMN Visited Public Land Mobile Network
WLAN Wireless Local Area Network

We claim:

1. An apparatus comprising
at least one processor; and
at least one memory storing instructions that, when executed by the at least one processor, cause the apparatus at least to:
attach to a visited public land mobile network as an inbound roamer;
receive, from an application function, a service announcement comprising at least one of a multicast service session allowed to be accessed by inbound roamers indication or multicast service class;
determine, based on the service announcement, whether the apparatus is allowed to access a multicast session or multicast service class in the visited public land mobile network;
transmit, in response to determining that the apparatus is allowed to access, a request to join a multicast session comprising an identifier of the multicast session and/or a multicast service class; and
receive an indication of an acceptance or rejection of the request to join the multicast session.

2. The apparatus of claim 1, wherein the instructions, when executed by the at least one processor, further cause the apparatus at least to:
register with the visited public land mobile network; and
establish a local break out protocol data unit session.

3. The apparatus of claim 1, wherein the service announcement indicates at least one public land mobile network of allowed or disallowed inbound roamers.

4. The apparatus of claim 1, wherein the indication of rejection of the request to join the multicast session contains an indication that access to the multicast session is not permitted for an inbound roamer.

5. An apparatus comprising
at least one processor; and
at least one memory storing instructions that, when executed by the at least one processor, cause the apparatus at least to:
handle a local breakout packet data unit session for an inbound roamer user equipment;
receive a join request of the inbound roamer user equipment for a multicast service session or a multicast service class;
determine, based on multicast roaming authorization information for the multicast service session or a multicast service class and/or the inbound roamer, whether to accept the join request; and
send a join reply message indicating whether the join request is accepted or rejected.

6. The apparatus of claim 5, wherein the instructions, when executed by the at least one processor, further cause the apparatus at least to:
retrieve user equipment multicast service subscription data from a unified data manager comprising at least one of:
an indication whether the apparatus is authorized to access multicast services while roaming;
identities of visited public land mobile network where the apparatus is authorized to access multicast services while roaming;
identities of visited public land mobile network where the apparatus is not authorized to access multicast services while roaming;
multicast service classes that the apparatus is authorized to access while roaming; or
multicast service classes that the apparatus is not authorized to access while roaming,
wherein the apparatus multicast service subscription data is used in determining whether to accept the join request.

7. The apparatus of claim 5, wherein the instructions, when executed by the at least one processor, further cause the apparatus at least to:
retrieve information about the context status of the multicast service session or multicast service class from a multicast session management function comprising at least one of:
an indication whether the multicast service session or multicast service class is allowed to be accessed by inbound roaming user equipment;
identities of home public land mobile network of inbound roaming user equipment authorized to access multicast service session or multicast service class;
identities of home public land mobile network of inbound roaming user equipment not authorized to access multicast service session or multicast service class; or
the multicast service class for the multicast service session,
wherein the apparatus multicast service subscription data is used in determining whether to accept the join request.

8. The apparatus of claim 5, wherein the join reply message indicating that the join request is rejected comprises an error cause indicating that access to the multicast service session or multicast service class is not permitted for an inbound roamer.

9. An apparatus comprising
at least one processor; and
at least one memory storing instructions that, when executed by the at least one processor, cause the apparatus at least to:
determine whether a multicast session or multicast service class is open to inbound roamers, resulting in a determination; and
transmit, based on the determination, a service announcement for a multicast session or service class indicating whether inbound roamers are allowed to access the multicast service or multicast service class.

10. The apparatus of claim 9, wherein the service announcement further indicates at least one home public land mobile network of allowed or disallowed inbound roamers.

11. The apparatus of claim 9, wherein the determination is based on configured information.

12. The apparatus of claim 9, wherein the instructions, when executed by the at least one processor, further cause the apparatus at least to:
request establishment of the multicast service from a network entity and indicating in the request whether inbound roamers are allowed to access the multicast service.

13. The apparatus of claim 9, wherein the instructions, when executed by the at least one processor, further cause the apparatus at least to:
request establishment of the multicast session from a network entity; and
receive a reply to the request comprising at least one of a second indication whether inbound roamers are allowed to access the multicast session, identities of home public land mobile network of inbound roaming user equipment authorized to access multicast service session, or identities of home public land mobile network of inbound roaming user equipment not authorized to access multicast service session,
wherein the determination is based on the second indication.

14. The apparatus of claim 9, wherein the instructions, when executed by the at least one processor, further cause the apparatus at least to:
indicate the service class in the request for the establishment of the multicast session.

15. An apparatus comprising
at least one processor, and
at least one memory storing instructions that, when executed by the at least one processor, cause the apparatus at least to:
receive a request for establishment of a multicast session from a network entity;
determine whether inbound roamers are allowed to access the multicast session, resulting in a determination; and
transmit a response to the request indicating whether inbound roamers are allowed to access the multicast session.

16. The apparatus of claim 15, wherein the request for the establishment of the multicast session comprises a multicast service class.

17. The apparatus of claim 15, wherein the determination is based on at least one of:
an identity of the network entity;
the multicast service class;
configured information; or
information obtained from a database.

18. The apparatus of claim 15, wherein the instructions, when executed by the at least one processor, further cause the apparatus at least to:
send a request for establishment of the multicast session, wherein the request comprises an indication whether inbound roamers are allowed to access the multicast service.

19. The apparatus of claim 15, wherein the instructions, when executed by the at least one processor, further cause the apparatus at least to:
derive a service class for the multicast session based on configured information related to a service class for the network entity and/or a service class for the identifier of the multicast session and/or a default service class; and
send either a request for the establishment of the multicast session or a reply to the request for the establishment of the multicast session, wherein the request or the reply comprises the service class.

20. The apparatus of claim 15, wherein the instructions, when executed by the at least one processor, further cause the apparatus at least to:
receive a subscription request for the context status of the multicast service session or multicast service class from a session management function; and
transmit context status of the multicast service session or multicast service class, comprising at least one of:
an indication whether the multicast service session or multicast service class is allowed to be accessed by inbound roaming user equipment;
identities of home public land mobile network of inbound roaming user equipment authorized to access multicast service session or multicast service class;
identities of home public land mobile network of inbound roaming user equipment not authorized to access multicast service session or multicast service class; or
the multicast service class for the multicast service session.
